(19) United States
(12) Patent Application Publication
(10) Pub. No.: US 2011/0225023 A1
(43) Pub. Date: Sep. 15, 2011

(54) Prioritized Product Distribution

(75) Inventors: Bridget Mary Evens, Coon Rapids, MN (US); Beverly Alice Elmshauser, Golden Valley, MN (US); Imtiaz Anwar, Hopkins, MN (US); Karrie Haugen, Plymouth, MN (US); Natasha Werner, Delano, MN (US); Katherine Grace Phillips, Minneapolis, MN (US); Karina Nelson, Minnetonka, MN (US)

(73) Assignee: Target Brands, Inc., Minneapolis, MN (US)

(21) Appl. No.: 12/720,178

(22) Filed: Mar. 9, 2010

(51) Int. Cl. G06Q 10/00

(52) U.S. Cl. 705/7.31

(57) ABSTRACT

In one embodiment, a distribution server can be configured to coordinate the distribution of products to multiple retail locations. Upon receiving data representative of a product, one or more retail locations, and a promotional event, the distribution server may predict an effect on product sales from the promotional event, generate a sales forecast for each of the locations, and determine a quantity of the product to be delivered to each of the locations. Based at least in part on receiving capabilities of the retail locations, the distribution server may determine a confidence level for each of the locations associated with a probability that the product is stocked at a particular time. The distribution server may prioritize product distribution to the retail locations, based at least in part on the determined confidence levels.

### BACKGROUND

At stores operated by a retailer a variety of products are available for customer purchase. Information related to product sales and inventory is collected and stored by computer systems maintained by the retailer and is used for generating decisions regarding product distribution and inventory replenishment. If the retailer is associated with a retail chain, such decisions are generally made under the direction of centralized management.

Using the product sales information, sales trends are identified for each of the stores. For example, sales of a particular product may be determined to be seasonal, or may be found to vary among stores or regions. For each of the stores, the sales trends are used to forecast product sales.

Using the product inventory information and the product sales forecasts, calculations are performed to determine product quantities to be delivered to each of the stores, in order to replenish store inventory. Thus, the stores remain stocked with products as future customers make future product purchases. Orders for product delivery are generated and provided to a distributer for fulfillment.

In retail chain environments, product distribution is generally performed at one or more distribution centers. Based on the delivery orders, distribution center employees collect products (from a warehouse, for example) and load the products onto vehicles. The products are subsequently transported to the stores, unloaded, and made available for purchase by store customers.

### SUMMARY

In one embodiment, a distribution server can be configured to coordinate the distribution of products to multiple retail locations. Upon receiving data representative of a product, one or more retail locations, and a promotional event, the distribution server may predict an effect on product sales from the promotional event, generate a sales forecast for each of the locations, and determine a quantity of the product to be delivered to each of the locations. Based at least in part on receiving capabilities of the retail locations, the distribution server may determine a confidence level for each of the locations associated with a probability that the product will be stocked at a particular time. The distribution server may prioritize product distribution to the retail locations, based at least in part on the determined confidence levels.

The promotional event is optionally related to advertising for the product. For example, a sale event can include a timeframe with a start and an end, and the prioritization of product distribution can be based at least in part on the timeframe. Optionally, the prioritization process assigns a higher priority for distribution of the product to one or more of the retail locations before the start of the event. As another option, the prioritization process assigns a lower priority for distribution of the product to one or more of the retail locations for which shipping schedules will not permit sufficient quantities of product to be delivered in time to satisfy customer demand. Optionally, the prioritization is also based at least in part on product aspects such as release date, expiration date, retailer pricing, and competitor pricing.

Optionally, non-promotional events or conditions are considered. For example, weather conditions, traffic conditions, and construction conditions can be recognized and a potential effect on product sales can be predicted. As another option, product sales trends are identified and validated by the distribution server. For example, the sales trends can be validated by performing a trend comparison between multiple retail locations. As another option, the receiving, unloading, or stocking schedules of one or more of the retail locations are variable. For example, the prioritization of product distribution can include a schedule adjustment for one of more of the locations. As another option, an agent for product distribution to one or more of the retail locations is variable. For example, selection of the distribution agent can be based on receiving capabilities of the retail locations and on delivery capabilities of the distribution agent.

The details of one or more implementations are set forth in the accompanying drawing and description below. Other features, objects, and advantages will be apparent from the description and drawings, and from the claims.

### DESCRIPTION OF DRAWINGS

FIG. 1 shows an example system for distributing products to retail locations.

FIG. 2 is a block diagram of an example process for recognizing events and conditions potentially affecting sales of one or more products.

FIG. 3 is a block diagram of an example process for forecasting product sales for one or more retail locations.

FIG. 4 is a block diagram of an example process for prioritizing product distribution to one or more retail locations and for creating distribution orders.

FIG. 5 is a flow chart showing an example process for distributing products to retail locations.

FIG. 6 is a flow chart showing an example process for determining product quantities for distribution to retail locations.

FIG. 7 is a block diagram of a generic computing system optionally used in connection with computer-implemented methods described in this document.

Like reference symbols in the various drawings indicate like elements.

### DETAILED DESCRIPTION OF ILLUSTRATIVE IMPLEMENTATIONS

Illustrative implementations of computer-based systems and methods for distributing products to one or more retail locations are described. The described systems and methods enable a distribution center in a retail chain environment to distribute products based at least in part on projected product sales. For example, the potential effect of a promotional event on product sales is determined, and merchandise is distributed to stores in advance of the event in order to capitalize on the projected sales. During the event, for example, actual sales are determined, and additional merchandise is intelligently distributed to one or more of the stores to compensate for distribution inaccuracies, and to capture additional sales for the remainder of the event.

The described system and methods also enable the distribution center to capitalize on its delivery capabilities (and the delivery capabilities of associated product vendors), and on the receiving capabilities of the various retail locations. For example, a store may operate under a fixed schedule for receiving merchandise deliveries from the distribution center, such that inventory adjustments are accomplished by altering the delivered product quantities, as opposed to altering the delivery schedule. As another example, a store may operate under a flexible receiving schedule, such that inventory adjustments are accomplished by either altering the delivered product quantities or by altering the delivery schedule. Such factors are considered when distributing products to the various retail locations.

Additionally, historical receiving data is used to predict the amount of time for unloading a delivery vehicle and stocking the store with delivered products. By including a prediction of the period of time between the arrival of a delivery vehicle and the stocking of a product, an accurate determination of potential lost sales is determined for the various retail locations. As promotional events generally run under a finite time period, if a determination is made for a certain store that an amount of product is subject to lost sales, the product may be routed to one or more stores that are predicted to unload and stock the product in time to capitalize on potential sales. Additionally, by routing product delivery away from stores subject to lost sales, an opportunity to save in unproductive inventory is created.

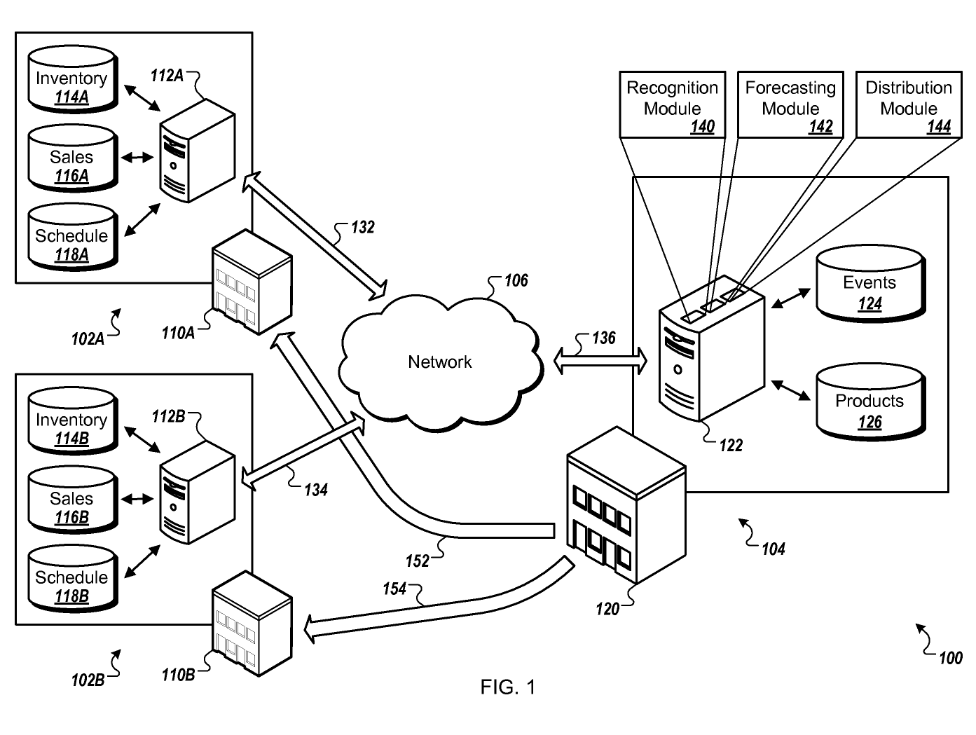

Referring to FIG. 1, an example system 100 for distributing products is shown. In some configurations, the distribution system 100 includes subsystems such as one or more retail systems and one or more distribution systems. For purposes of illustration, the system 100 shown in FIG. 1 includes a retail system 102A, a retail system 102B, and a distribution system 104. In some configurations, each of the retail systems (102A, 102B, etc.) includes components such as a retail server (112A, 112B, etc.), an inventory data store (114A, 114B, etc.), a sales data store (116A, 116B, etc.), and a schedule data store (118A, 118B, etc.). Each of the retail systems (102A, 102B, etc.) is associated with a retail location (110A, 110B, etc.), for example, a physical store at which customers may purchase products. In some configurations, the distribution system 104 includes components such as a distribution server 122, an events data store 124, and a products data store 126. The distribution system 104 is associated with a distribution center 120, for example, a physical warehouse where products are loaded onto vehicles for transport to stores. Components and subsystems included in the system 100 communicate via a network 106 using wired or wireless protocols, or a combination thereof.

Decisions generated within the system 100 regarding product distribution are based at least in part on information associated with the retail locations 110A, 110B, etc. For example, information related to retail location 110A inventory is retrieved by the retail server 112A from the inventory data store 114A. Similarly, for example, information related to retail location 110B inventory is retrieved by the retail server 112B from the inventory data store 114B. Inventory information includes available product quantities (e.g., products stocked on store shelves, products in backroom or warehouse storage, etc.), as well as capacities for storing and managing inventory (e.g., retail area capacity, warehouse capacity, shrinkage rates, damage rates, markdown rates, etc.).

In the present example, information related to retail location 110A product sales is retrieved by the retail server 112A from the sales data store 116A, and information related to retail location 110B product sales is retrieved by the retail server 112B from the sales data store 116B. Sales information includes historical product sales data (e.g., transaction timestamps, values and quantities of products sold, purchasing customer data, method of payment, etc.). Optionally, sales information also includes information related to events and conditions related to the sale (e.g., whether a purchased product was included in a promotional event, customer use of coupons, etc.).

In the present example, information related to retail location 110A scheduling is retrieved by the retail server 112A from the schedule data store 118A, and information related to retail location 110B scheduling is retrieved by the retail server 112B from the schedule data store 118B. Scheduling information includes retail location product receiving and stocking data (e.g., receiving schedules, historical unloading times by product, historical stocking times by product, etc.).

Optionally, data stored and provided by each of the inventory data stores (114A, 114B, etc.), each of the sales data stores (116A, 116B, etc.), and each of the schedule data stores (118A, 118B, etc.) may be provided by a centralized data store (not shown) maintained by the distribution center 120 or some other location. As another option, data may be stored and provided by one or more additional databases.

Decisions generated within the system 100 regarding product distribution are also based at least in part on information accessed and maintained by the distribution server 122. In the present example, information related to events and conditions (e.g., promotional events, weather conditions, etc.) potentially affecting product sales by one or more retail locations (110A, 110B, etc.) is retrieved by the distribution server 122 from the events data store 124. Additionally, for example, information related to products to be distributed to retail locations (110A, 110B, etc.) is retrieved by the distribution server 122 from the products data store 126. Product information (e.g., quantities on hand, vendor delivery schedules, shipping requirements, etc.) is maintained for each of the products distributed within the system 100, for example. Optionally, the data stores 124, 126 may be merged. As another option, the data stores 124, 126 may be partitioned into one or more additional data stores.

As shown by communication arrows 132, 136, data retrieved by the retail server 112A is provided to the distribution server 122. Similarly, as shown by communication arrows 134, 136, data retrieved by the retail server 112B is provided to the distribution server 122. Optionally, the retail servers (112A, 112B, etc.) may be configured to retrieve and provide information as part of a batch process. As another option, the distribution server 122 may be configured to request specific information from each of the retail servers (112A, 112B, etc.) as required by running system processes. The servers 122, 112A, 112B, etc. each include one or more memory devices (e.g., RAM, hard drives, etc.) and computer processors (e.g., single-threaded CPUs, multi-threaded CPUs, etc.) to store and perform computer-based instructions for providing operations related to product distribution within the system 100, for example.

To provide operations related to product distribution, in the present example, the distribution server 122 includes one or more software modules such as a recognition module 140, a forecasting module 142, and a distribution module 144. However, in some arrangements, the functionality of one or more of the modules may be incorporated into a hardware system or a combination of hardware and software. Further, while three distinct modules (i.e., the recognition module 140, the forecasting module 142, and the distribution module 144) are illustrated, in some arrangements, the functionality of the modules may be combined into a single module or may be distributed across additional modules (e.g., four or more). Optionally, functional aspects of the recognition module 140, the forecasting module 142, or the distribution module 144 are performed by one or more of the retail servers (112A, 112B, etc.), alone or in concert with the distribution server 122.

To illustrate operations of the system 100, in an example scenario, the distribution server 122 receives information related to a product from the products data store 126 and receives relevant inventory, sales, and schedule information from one or more of the retail systems 102A, 102B, etc. For example, the product may be included in a promotional event (e.g., an advertising campaign, a price reduction, etc.) implemented by a retail chain managing one or more of the retail locations 110A, 110B, etc. Information related to the promotional event (e.g., event start date and end date, event coverage area, methods for promoting the event, etc.) is stored in the events data store 124, for example, and is accessible by the distribution server 122. For example, using the recognition module 140, the distribution server 122 recognizes the promotional event as potentially affecting product sales of one or more of the retail locations 110A, 110B, etc. Optionally, for the recognized event, the recognition module 140 predicts a degree of influence on product sales.

For each of the retail locations (110A, 110B, etc.), the distribution server 122 optionally identifies a product sales trend. Based on historical sales transaction data associated with the product (e.g., data provided by the sales data stores 116A, 116B, etc.), for example, the distribution server 122 projects product sales over a period of time (e.g., an event timeframe identified by the recognition module 140). For example, the distribution server 122 uses the forecasting module 142 to identify product sales trends for each of the retail locations (110A, 110B, etc.), and to forecast product sales based at least in part on the identified sales trends and at least in part on the predicted affect on sales attributed to the recognized event. The product sales forecasts are used as factors in determining product quantities to be delivered to each of the retail locations (110A, 110B, etc.), for example.

In the present example scenario, the distribution server 122 uses the distribution module 144 to determine product quantities for distribution, to prioritize product distribution, and to generate distribution orders. For example, the distribution server 122 receives data related to retail location receiving attributes (e.g., data provided by the schedule data stores 118A, 118B, etc., and by the inventory data stores 114A, 114B, etc.), including information such as current and historical unload schedules, current and historical stocking times, retail area or store floor capacity, warehouse or backroom capacity, shrinkage rates, damage rates, markdown rates, etc. Additionally, for example, the distribution server 122 receives data related to retail location product inventory (e.g., data provided by the inventory data stores 114A, 114B, etc.), including information such as product quantities stocked on store shelves, product quantities in backroom storage, etc.

Based at least in part on the identified receiving attributes of each of the retail locations (110A, 110B, etc.), and optionally based at least in part on product inventory information, the distribution server 122 calculates a confidence level (e.g., using the distribution module 144) for each of the locations, representative of a probability that the product is stocked at the location at a particular time. For example, it may be determined, based at least in part on product inventory and forecasted sales, that a high probability (e.g., 90%, 95%, 99%, etc.) exists that product quantities will be depleted at the retail location 110A at a particular time (e.g., Monday at 1:00 PM), and that a similar probability exists that product quantities will be depleted at the retail location 110B at another time (e.g., Monday at 5:00 PM). As another example, it may be determined that at a particular time (e.g., Monday at 10:00 AM), a certain probability (e.g., 50%) exists that product quantities will be available at retail location 110A, and that for the same particular time, another probability (e.g., 60%) exists that product quantities will be available at retail location 110B. As another example, based on current and historical unload schedules and stocking times, it may be determined that if the retail location 110A receives a product shipment at a certain time (e.g., Tuesday at 7:00 AM, a receiving time for retail location 110A), a certain probability (e.g., 80%) exists that the product will be stocked at that location at a particular time (e.g., Tuesday at 10:00 AM). Correspondingly, for example, it may be determined that if the retail location 110B receives a product shipment at a certain time (e.g., Tuesday at 6:00 AM, a receiving time for retail location 110B), a certain probability (e.g., 70%) exists that the product will be stocked at that location at a similar time (e.g., Tuesday at 10:00 AM). As another example, it may be determined that a high probability (e.g., 90%, 95%, 99%, etc.) exists that retail location 110A will have the product stocked at a particular time (e.g., Tuesday at 11:00 AM), and that a similar probability exists that retail location 110B will have the product stocked at another time (e.g., Tuesday at 11:30 AM). Confidence levels may be calculated using common statistical methods.

Product quantities to be delivered to the retail locations 110A, 110B, etc. are determined (e.g., by the distribution server 112 using the distribution module 144), based at least in part on forecasted sales, and optionally, on product inventory levels. For example, a new product may not be initially included in the inventory of the retail locations 110A, 110B, etc. In the present example, forecasted sales for each of the retail locations 110A, 110B, etc. are used for determining the product quantities to be delivered. As another example, an existing product may be included in the inventory of the retail locations 110A, 110B, etc., and a combination of product inventory levels and forecasted sales, as well as information related to capacities for storing and managing inventory (e.g., retail area capacity, warehouse capacity, shrinkage rates, damage rates, etc.) are used for determining the product quantities to be delivered.

Based at least in part on the identified receiving attributes of each of the retail locations (110A, 110B, etc.) and on the calculated confidence levels, the distribution server 122 prioritizes distribution of the product (e.g., using the distribution module 144) to the retail locations. In the present example scenario, it is determined that a certain quantity (e.g., 150 units) of a particular product is available for distribution by the distribution center 120. It is also determined, for example, that over the course of the recognized event, the retail location 110A is forecasted to sell a particular quantity (e.g., 100 units) of the product, and the retail location 110B is forecasted to sell another quantity (e.g., 90 units). However, based at least in part on the identified receiving attributes and calculated confidence levels of the retail locations 110A, 110B, it is determined that retail location 110A is capable of stocking the product earlier than the retail location 110B. Additionally, for example, it is determined that retail location 110B may be subject to lost sales during the event, as the retail location 110B is predicted to be out of stock during at least a portion of the promotional event. Based on such information, for example, the distribution module 144 prioritizes the product distribution, adjusting the determined quantities to be delivered (e.g., by increasing the number of units to be delivered to retail location 110A and decreasing the number of units to be delivered to retail location 110B).

Based on the adjusted quantities to be delivered to each of the retail locations (110A, 110B, etc.), the distribution server 122 generates distribution orders for delivering the product quantities. For example, based at least in part on retail location receiving schedules (e.g., retrieved from the schedule data stores 118A, 118B, etc.), the distribution module 144 generates a distribution order for the retail location 110A, and another distribution order for the retail location 110B. Products are loaded onto one or more delivery vehicles (e.g., by employees at the distribution center 120), based on the distribution orders. As shown by delivery arrows 152, 154, products are delivered by the distribution center 120 to the retail locations 110A, 110B, where the products are unloaded (e.g., by retail location employees), and stored in inventory or stocked. Optionally, data collection devices (e.g., handheld computers, scanners, etc.) are employed to track receiving information (e.g., receiving times, unload times, stocking times, etc.) and inventory information (e.g., products received, quantities received, etc.). For example, the receiving information is stored by the various schedule data stores (118A, 118B, etc.) and the inventory information is stored by the various inventory data stores (114A, 114B, etc.). Such data can be used by the distribution server 122, for example, for generating and refining subsequent decisions and processes.

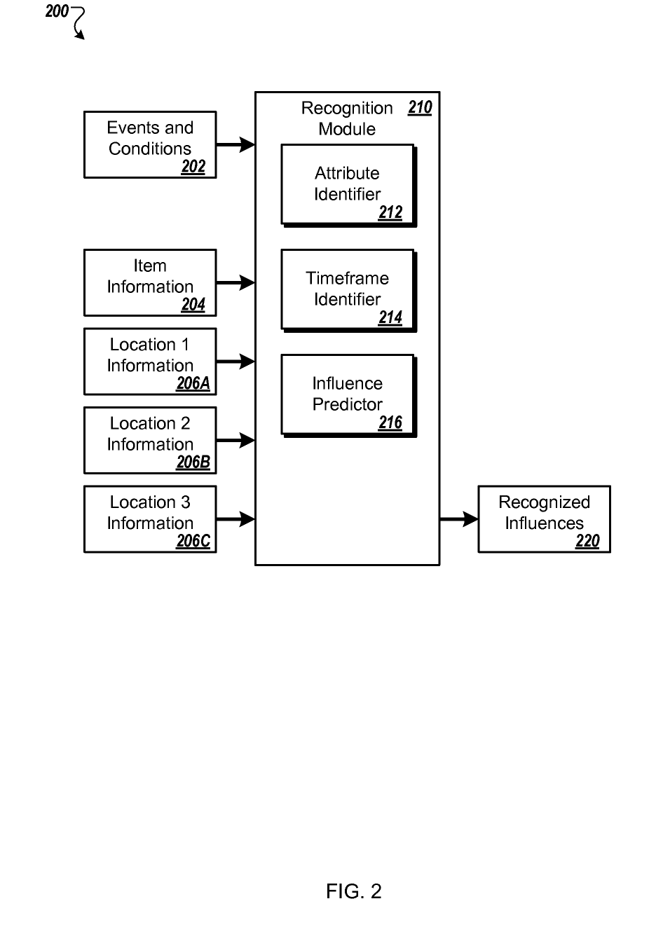

FIG. 2 is a block diagram of an example process 200 for recognizing events and conditions potentially affecting sales of one or more products. For example, the process 200 is optionally performed by the system 100 as shown in FIG. 1 (e.g., by the recognition module 140). As shown, the process 200 receives input data (i.e., events and conditions, product information, retail location information), performs a variety of data identification and data analysis functions, and recognizes one or more influences associated with the events or conditions determined to potentially affect product sales. Optionally, one or more of recognized influences are used as factors for forecasting product sales by one or more retail locations.

Inputs to the process 200 include events and conditions 202. For example, the events and conditions 202 include information related to one or more products, such as advertising (e.g., retailer advertising, competitor advertising, etc.), price reductions, reviews, news articles, etc.). Additionally, the events and conditions 202 include information related to one or more retail locations, such as temporal factors (e.g., seasonal, holiday, etc.), weather conditions, traffic conditions, construction updates, etc. Optionally, the events and conditions 202 are maintained and provided by a database or other type of file system (e.g., the events data store, as shown in FIG. 1). As another option, the events and conditions 202 are provided by multiple sources. For example, retailer advertising may be provided by an advertising data store (not shown) maintained by the retailer. Information such as advertising event start and end dates, advertising medium, advertising coverage, product, and price are added and maintained, for example, as part of managing an advertising campaign. As another example, information external to the retailer (e.g., competitor advertising, competitor product pricing, etc.) is collected, and accessed via a competitor-related data store (not shown) maintained by the retailer. Optionally, additional external information (e.g., product reviews, news articles referring to products or retail locations, weather conditions, traffic conditions, construction updates, etc.) is maintained by one or more entities external to the retailer, and is accessed directly (e.g., by the distribution system 104, via a provided web service interface) or indirectly (e.g., by the distribution system 104, via a web crawler, screen scraper, or other data collection method).

Inputs to the process 200 also include item information 204. For example, the item information 204 includes information related to one or more products offered for sale by the retailer, such as item identifiers, product release dates, expiration dates, pricing, transportation requirements, storage requirements, etc. Optionally, the item information 204 is maintained and provided by a database or other type of file system (e.g., the products data store 126, as shown in FIG. 1).

Additionally, inputs to the process 200 include information related to one or more retail locations (e.g., location information 206A, 206B, 206C, etc.). For example, the location information 206A-C includes information such as geographical information, retail location receiving attributes (e.g., current and historical unload schedules, current and historical stocking times, warehouse or backroom capacity, retail area capacity, etc.), retail location operation schedules, etc. Optionally, the location information 206A-C is provided by one or more retail locations (e.g., by the retail systems 102A, 102B, etc., as shown in FIG. 1). As another option, location information for multiple retail locations is provided by a centralized data store.

The process 200 performs a variety of functions for analyzing input data and identifying relevant events or conditions. As shown, the functions are coordinated by a software module such as a recognition module 210. Functions of the recognition module 210 are optionally performed by one or more computer processors (e.g., the distribution server 122, as shown in FIG. 1), and in some implementations, the recognition module 210 may be similar to the recognition module 140 (as shown in FIG. 1). The recognition module 210 identifies attributes of the events and conditions 202 which are potentially relevant to sales of a product (e.g., as defined by the item information 204), identifies a relevant timeframe for an event or condition, and predicts whether an event or condition will have an influence on product sales, for one or more retail locations (e.g., as defined by the location information 206A, 206B, 206C, etc.).

To identify attributes of potentially relevant events and conditions, the recognition module 210 optionally uses an attribute identifier 212. For example, for a promotional event (e.g., an advertised event), identified attributes include factors related to the promotion, such as medium, message, coverage, etc. Possible advertising mediums, for example, include television, radio, newspaper, etc. Factors included in an advertising message, for example, include advertising placement, length, etc. For example, a print advertisement (e.g., an advertising circular, a newspaper advertisement, etc.) may be identified as having a certain placement (e.g., first page, middle page, back page, etc.) and a certain length (e.g., quarter page, half page, full page, etc.). As another example, a television or radio advertisement may be identified as having a certain placement (e.g., first slot, middle slot, last slot) and a certain length (15 seconds, 30 seconds, 1 minute, etc.). Additionally, for example, an advertising message is determined to be relevant to a particular product (e.g., a product defined by the item information 204) and one or more retail locations (e.g., one or more of the locations as defined by the location information 206A-C). Advertising coverage, for example, includes such factors as audience size and demographics, geographic range, etc. It may be determined, for example, that one or more retail locations (e.g., one or more of the locations as defined by the location information 206A-C) are included in the geographic range covered by the advertisement. Attributes of other media-related events (e.g., competitor advertising, product news, product reviews, etc.) may be similarly identified by the recognition module 210 using the attribute identifier 212.

Correspondingly, condition attributes (e.g., weather, construction, traffic, etc.) are optionally identified by the recognition module 210 using the attribute identifier 212. For example, the attribute identifier 212 may identify various weather attributes (e.g., precipitation, snow, wind, temperature, etc.) associated with a weather forecast for a particular geographic location (e.g., an area including one or more locations as defined by the location information 206A-C). As another example, the attribute identifier 212 optionally identifies various traffic attributes (e.g., free-flowing, congested, etc.) or construction attributes (e.g., scope of construction, range of a construction zone, etc.) which potentially affect the flow of vehicular traffic and travel times for the geographic location.

To identify a relevant timeframe for an event or condition, the recognition module 210 optionally uses a timeframe identifier 214. For example, a promotional event may be determined to be in effect for a particular duration (e.g., a day, a week, a month, etc.), and the timeframe (i.e., start time, end time, duration) is identified by the timeframe identifier 214. Similarly, timeframes may be defined for other media-related events and conditions. For example, a news article describing a particular product may be determined to be included in a magazine published during a particular week or month. As another example, a particular weather condition may be determined to be prevalent for a particular period of time.

To predict whether an event or condition potentially influences product sales, the recognition module 210 optionally uses an influence predictor 216. For example, the attribute identifier 212 may determine that an advertisement associated with the retailer is to be printed in a particular newspaper having a readership of a certain level (e.g., 100,000 people) in a particular newspaper section (e.g., second page), and that the advertisement is to be of a particular size (e.g., a half page). Additionally, for example, it may be determined that the advertisement relates to a particular product (e.g., an umbrella) included in the item information 204, and that the advertisement also relates to one or more of the retail locations included in the location information 206A-C. The timeframe identifier 214, for example, may determine that the advertisement relates to a promotion starting the day after Thanksgiving, with a duration of one week. As another example, the attribute identifier 212 may determine that predicted weather conditions (e.g., rain) may affect sales of a particular product or class of products (e.g., umbrellas, raincoats, etc.) for a particular geographic location, and the timeframe identifier 214 may determine that the weather condition is to persist for a particular length of time (e.g., a day, a week, etc.). Based on such identified event and condition attributes and timeframes, and based on historical product sales during time periods associated with similar events and conditions, for example, the influence predictor 216 determines whether an event or condition (e.g., the advertisement, the rain condition, etc.) may influence sales of the product (e.g., the umbrella) at one or more locations associated with the location information 206A-C. Optionally, the influence predictor 206 determines a degree of influence on product sales at one or more retail locations.

One or more recognized influences 220 are identified by the process 200 as potentially affecting sales of the product (e.g., as defined by the item information 204) by one or more retail locations (e.g., as defined by the location information 206A, 206B, 206C, etc.). The recognized influences 220, for example, may include relevant information previously identified by the attribute identifier 212 and the timeframe identifier 214. Optionally, information associated with the recognized influences 220 are used by subsequent processes as factors for forecasting product sales.

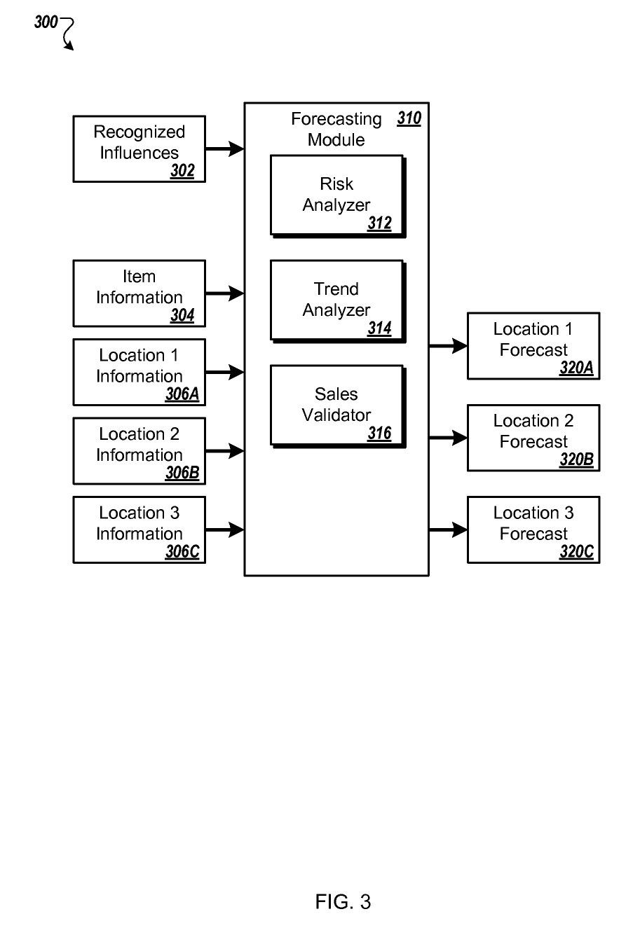

FIG. 3 is a block diagram of an example process 300 for forecasting product sales for one or more retail locations. For example, the process 300 is optionally performed by the system 100 as shown in FIG. 1 (e.g., by the forecasting module 142). As shown, the process 300 receives input data (i.e., recognized factors determined to potentially influence product sales, product information, location information), performs a variety of data analysis and data validation functions, and generates product sales forecasts for one or more retail locations. Optionally, the sales forecasts are used as factors for prioritizing product distribution and for generating distribution orders.

Inputs to the process 300 include recognized influences 302. For example, the recognized influences 302 may be associated with information identified as potentially affecting product sales by one or more locations. Optionally, the recognized influences 302 are identified by the process 200 as shown in FIG. 2. Inputs to the process 300 also include item information 304 and information related to one or more retail locations (e.g., location information 306A, 306B, 306C, etc.). For example, the item information 304 is optionally similar to the item information 204 (shown in FIG. 2), and the location information 306A-C is optionally similar to the location information 206A-C (also shown in FIG. 2).

The process 300 performs a variety of functions for analyzing risks and trends, and for validating sales projections. As shown, the functions are coordinated by a software module such as a forecasting module 310. Functions of the forecasting module 310 are optionally performed by one or more computer processors (e.g., the distribution server 122, as shown in FIG. 1), and in some implementations, the forecasting module 310 may be similar to the forecasting module 142 (as shown in FIG. 1). The forecasting module 310 analyzes product sales and distribution risks and trends for one or more retail locations, based on the recognized influences 302, the item information 304, and the location information 306A-C. Additionally, the forecasting module 310 validates sales trends of the retail locations by performing a trend comparison for one of more of the locations (e.g., as defined by the location information 306A, 306B, 306C, etc.).

To determine a level of sensitivity and risk related to product sales and distribution, the forecasting module 310 optionally uses a risk analyzer 312. For example, information associated with the recognized influences 302 may be used to determine the level of risk related to sales of a particular product (e.g., a product defined by the item information 304) by one or more retail locations (e.g., one or more of the locations as defined by the location information 306A-C). Previously identified attributes (e.g., as identified by the attribute identifier 212, shown in FIG. 2) and timeframes (e.g., as identified by the timeframe identifier 214, also shown in FIG. 2) related to various events and conditions are optionally used as factors by the risk analyzer 312. For example, considering a retailer promotional event, media medium attributes such as an advertisement placement (e.g., front cover, insert pages, back page, etc.), message attributes such as an advertised product price (e.g., lowest price ever, 10% off, $5 off, etc.), and coverage attributes such as a relevant coverage area (e.g., a particular geographic area, a listing of retail locations participating in the promotional event, etc.) are used to determine an effect on product sales. As another example, considering a weather condition (e.g., a sunny forecast), the effect on sales for a particular product or class of products may be determined.

The determined effect on product sales of various identified attributes and timeframes may vary among different retail locations. For a particular product, for example, an advertisement including text stating that the product is to be sold for a reduced price at a particular group of stores for a particular period of time may be determined to increase sales of the product by one of the stores more than another during the time period. As another example, one of the stores may be determined to experience an increase in sales for an early portion of the timeframe, and a decrease in sales during a later portion of the timeframe. Methods for determining the particular effect on product sales by each of the stores include an analysis of historical product sales data (e.g., data associated with the location information 306A-C), based on identifying similarly associated event and condition attributes and timeframes (e.g., attributes and timeframes similar to those associated with the recognized influences 302) having been present prior to or during the time of sale.

To identify a product sales trend for one or more retail locations, the forecasting module 310 optionally uses a trend analyzer 314. For example, based on historical product sales data and on risks identified by the risk analyzer 312, the trend analyzer 314 may be used to predict sales of a product (e.g., as defined by the item information 304) by one or more retail locations (e.g., as defined by the location information 306A, 306B, 306C, etc.) over a particular period of time. Optionally, product sales may be predicted over particular time increments (e.g., weekly, daily, hourly, etc.) of the particular time period.

To validate an identified product sales trend for one or more retail locations, the forecasting module 310 optionally uses a sales validator 316. For example, the sales validator 316 compares product sales data of multiple retail locations to determine aberrations and to perform sales calculation modifications. The modifications, for example, can be used to further refine product sales projections. Additionally, validated sales trends can be used by the system 100 (shown in FIG. 1) to adapt to conditions associated with high or low product sales.

One or more location forecasts (e.g., location forecast 320A, 320B, 320C, etc.) are generated by the process 300 for projecting sales of a product (e.g., as defined by the item information 304) by one or more retail locations (e.g., as defined by the location information 306A, 306B, 306C, etc.). For example, the location forecasts 320A-C may include projected sales of the product over particular time increments (e.g., weekly, daily, hourly, etc.) over a particular time period (e.g., a time period corresponding to the duration of a promotional event, weather condition, etc.). Optionally, information associated with the generated location forecasts 306A-C is used by subsequent processes as a factor in prioritizing product distribution and generating distribution orders.

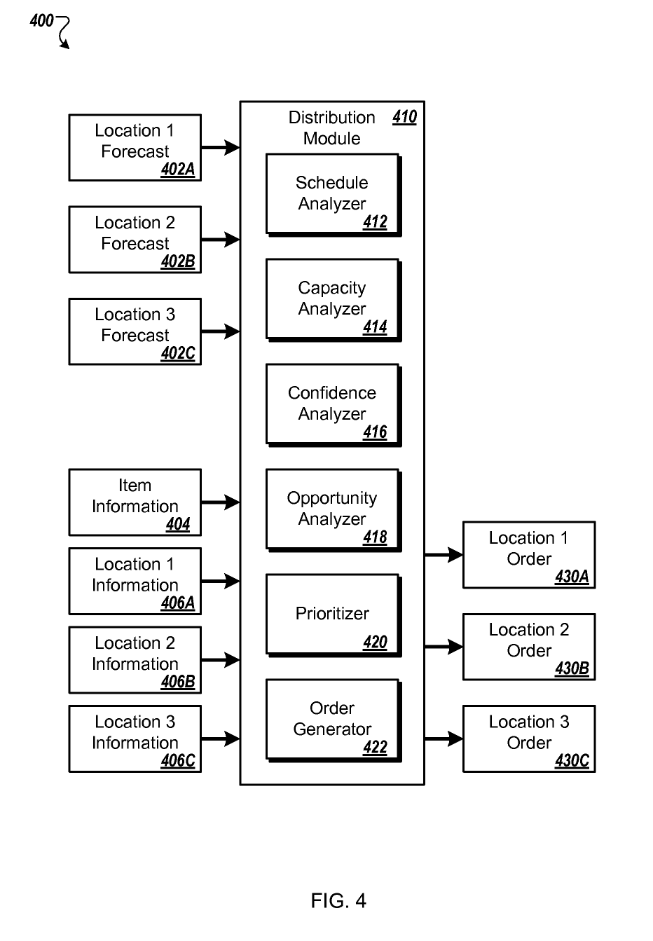

FIG. 4 is a block diagram of an example process 400 for prioritizing product distribution to one or more retail locations and for creating distribution orders. For example, the process 400 is optionally performed by the system 100 as shown in FIG. 1 (e.g., by the distribution module 144). As shown, the process 400 receives input data (i.e., one or more location sales forecasts, product information, retail location information), performs a variety of data analysis and prioritization functions, and generates distribution orders for one or more retail locations.

Inputs to the process 400 include location forecasts 402A, 402B, 402C, etc. For example, the location forecasts 402A-C include information related to forecasted product sales for one or more retail locations, based at least in part on previously identified sales data and at least in part on previously recognized influences identified as potentially affecting product sales by one or more of the locations. Optionally, the location forecasts 402A-C are generated by the process 300 as shown in FIG. 3. Inputs to the process 400 also include item information 404 and information related to one or more retail locations (e.g., location information 406A, 406B, 406C, etc.). For example, the item information 404 is optionally similar to the item information 204 (shown in FIG. 2) and the item information 304 (shown in FIG. 3). Additionally, the location information 406A-C is optionally similar to the location information 206A-C (shown in FIG. 2) and the location information 306A-C (shown in FIG. 3).

The process 400 performs a variety of functions for analyzing distribution schedules, capacity attributes, confidence levels, and opportunity factors associated with one or more retail locations. Additionally, the process 400 prioritizes and generates distribution orders for one or more of the locations. As shown, the functions are coordinated by a software module such as a distribution module 410. Functions of the distribution module 410 are optionally performed by one or more computer processors (e.g., the distribution server 122, as shown in FIG. 1), and in some implementations, the distribution module 410 may be similar to the distribution module 144 (as shown in FIG. 1). The distribution module 410 performs related functions, based on one or more location forecasts (e.g., the location forecasts 402A-C), item information 404, and the location information 406A-C.

To analyze the schedules (e.g., receiving, unloading, stocking, etc.) of one or more retail locations, the distribution module 410 optionally uses a schedule analyzer 412. For example, the schedule analyzer 412 identifies relevant aspects of schedules of one or more retail locations (e.g., one or more locations as defined by the location information 406A-C) to determine which of the locations may be considered to handle a high or low volume of product, or to determine which of the locations has a fixed or flexible product handling schedule. Certain retail locations, for example, may receive shipments of a product (e.g., as defined by the item information 404) on a fixed schedule (e.g., Monday morning at 7:00 AM, Thursday afternoon at 1:00 PM, etc.), and may unload and stock the product on a correspondingly fixed schedule. Other retail locations, for example, may receive, unload, or stock product shipments on a flexible or variable basis.

To analyze the capacities of one or more retail locations, the distribution module 410 optionally uses a capacity analyzer 414. For example, the capacity analyzer 414 identifies factors related to storage space (e.g., floor, retail area, backroom, warehouse, etc.) available for a particular product (e.g., as defined by the item information 404) at one or more retail locations (e.g., as defined by the location information 406A-C). Optionally, the capacity analyzer 414 identifies additional factors related to product availability (e.g., damage rates, shrinkage rates, markdown rates, etc.) and uses these factors in conjunction with product storage factors in subsequent calculations.

To analyze confidence levels associated with one or more retail locations, the distribution module 410 optionally uses a confidence analyzer 416. For example, the confidence analyzer 416 may be used to determine a probability that a product (e.g., as defined by the item information 404) is received, unloaded, or stocked at a particular location (e.g., as defined by the location information 406A-C) at a particular time. To determine the probabilities, the confidence analyzer 416 optionally analyzes historical receiving, unloading, and stocking information (e.g., times recorded via various data collection methods), comparing the data to historical receiving, unloading, and stocking schedules (e.g., as determined by the schedule analyzer 412). As another option, the confidence analyzer 416 considers one or more capacity attributes (e.g., as determined by the capacity analyzer 414) as factors in determining the probabilities. For example, the available floor space allocated for a product at a particular retail location, and product shrinkage rates may be used as factors for predicting sell-out times for the product, based at least in part on a product sales forecast for the location (e.g., any of the location forecasts 402A-C). By comparing actual and scheduled receiving, unloading, and stocking times for a retail location, and by considering one or more capacity-related attributes of the location, for example, the confidence analyzer 416 identifies product distribution trends (e.g., receiving, unloading, stocking, selling, etc.), and can determine a likelihood that product quantities will be available for purchase at a particular retail location at a particular time.

To analyze distribution and sales opportunities related to one or more retail locations, the distribution module 410 optionally uses an opportunity analyzer 418. For example, based on the distribution schedules (e.g., as determined by the schedule analyzer 412) of one or more retail locations, an opportunity may be identified for distributing products at more frequent intervals to locations having high frequency, variable, or flexible receiving schedules. As another example, based on the capacity attributes (e.g., as determined by the capacity analyzer 414) of one or more retail locations, an opportunity may be identified for distributing larger quantities of the product to locations having larger storage capacities (e.g., floor, retail area, backroom, warehouse, etc.). Optionally, certain retail locations (e.g., as defined by the location information 406A-C) may accept delivery of particular products (e.g., as defined by the item information 404) from multiple distribution agents (e.g., the distribution center 120, a vendor, etc.). The opportunity analyzer 418 may determine that one of the distribution agents is capable of distributing the particular products more efficiently or more timely than the others, for example.

As another option, the opportunity analyzer 418 identifies opportunities to distribute products prior to the start of a recognized event or condition (e.g., a promotional event, a forecasted weather condition, etc.). For example, a promotional event may be identified as starting on a Sunday and continuing to the following Saturday. Product sales (e.g., as detailed in any of the location forecasts 402A-C) may be predicted to increase on Sunday, for example, to decrease during the week, and to increase again on Friday and Saturday. The opportunity analyzer 418 identifies periods of time associated with increased or reduced sales, enabling subsequent processes to facilitate product distribution in advance of or during the time periods.

As another option, the opportunity analyzer 418 identifies opportunities to reduce unproductive inventory by not distributing for lost sales. For example, for a particular retail location associated with a promotional event related to a particular product (e.g., an advertised product sale starting on Sunday and continuing to the following Saturday), it may be determined that the location will run out of the product at a particular time (e.g., Friday at 3:00 PM). Due to a variety of factors (e.g., a fixed receiving schedule, limited product storage capacity, a product shortage, etc.), for example, it may not be feasible or possible to replenish the location with additional product quantities in time to prevent the location from running out of the product. In the present example, the retail location may be scheduled to receive a shipment of the product at a particular time (e.g., Friday at 1:00 PM), but it may be determined (e.g., by the confidence analyzer 416) that a high probability exists that the product will be stocked at 7:00 PM Friday, resulting in four hours of lost sales. Therefore, in the present example, the opportunity analyzer 418 may determine that the products that would have been sold by the location during the period of lost sales (e.g., four hours) should be distributed to another retail location (e.g., a location predicted to capitalize on product sales during the time period). Products that are predicted to be stocked and sold by the retail location for the remainder of the advertised event (e.g., forecasted sales between 7:00 PM Friday and the end of the event), as well as products that are predicted to be sold between the end of the event and the next stocking time, for example, are distributed to the location subject to lost sales.

To prioritize product distribution among one or more retail locations, the distribution module 410 optionally uses a prioritizer 420. For example, prioritization of distribution of a product (e.g., as defined by the item information 404) to one or more retail locations (e.g., as defined by the location information 406A-C) by the prioritizer 420 is based at least in part on location sales forecasts (e.g., as defined by the location forecasts 402A-C). Optionally, the prioritization is also based on location schedules (e.g., as determined by the schedule analyzer 412), location capacities (e.g., as determined by the capacity analyzer 414), location confidence levels (e.g., as determined by the confidence analyzer 416), and distribution and sales opportunities (e.g., as determined by the opportunity analyzer 418). For example, the prioritizer 420 optionally adjusts scheduled product distribution to one or more of the retail locations, based at least in part on receiving, unload, or stocking schedules (e.g., fixed, flexible, variable, etc.) of one or more of the locations. The adjustment, for example, may enable the distribution system 104 (shown in FIG. 1) to distribute products to the various locations in time to capitalize on forecasted sales opportunities, by leveraging the receiving capacities of the locations. As another example, the prioritizer 420 optionally adjusts product quantities to be delivered to one or more of the retail locations. For example, based at least in part on a timeframe associated with an identified event or condition determined to potentially affect product sales, the prioritizer 420 may adjust product delivery quantities. Prior to the start of a promotional event associated with one or more retail locations, for example, the prioritizer 420 may assign a higher preference or priority for product delivery to the affected locations. As another example, the prioritizer may assign a lower preference or priority for product delivery to locations projected to be subject to lost sales before the end of the promotional event.

Optionally, the prioritization of product distribution to one or more retail locations by the prioritizer 420 is based at least in part on identified aspects of the product. For certain products or product categories (e.g., movies, video games, etc), the product release date is optionally used as a factor in prioritization. One of the retail locations, for example, may be forecasted to sell a greater quantity of newly released movies in comparison to other locations (e.g., based on historical sales data), and the prioritizer 420 may assign a higher preference or priority for delivery to the appropriate location. As another option, product expiration is used as a factor in prioritization. For example, a product determined to be on clearance at a particular retail location may be forecasted to have a high level of sales, but the prioritizer 420 may assign a low preference or priority for delivery to the location, as the product is to be removed from inventory. As another option, retail pricing is used as a factor in prioritization. For example, a price reduction unrelated to a promotional event for a particular product at a particular retail location may be determined to increase product sales at the location, and the prioritizer 420 may assign a higher preference or priority for delivery to the location. Correspondingly, competitor pricing is optionally used as a factor in prioritization. For example, a price reduction at a competing store in the vicinity of a retail location, for a product similar to one or more products sold by the location, may be predicted to reduce sales by the location. In the present example, the prioritizer 420 may assign a lower preference or priority for delivery to the location.

To generate distribution orders for one or more retail locations, the distribution module 410 optionally uses an order generator 422. For example, orders for distribution of a product (e.g., as defined by the item information 404) to one or more retail locations (e.g., as defined by the location information 406A-C) generated by the order generator 422 are based at least in part on location sales forecasts (e.g., as defined by the location forecasts 402A-C). Optionally, the generated orders are also based on identified distribution and sales opportunities (e.g., as determined by the opportunity analyzer 418), and distribution prioritization (e.g., as determined by the prioritizer 420). For example, generated orders may indicate product quantities to be delivered, delivery schedules, delivery mechanisms (e.g., by truck, van, courier, etc.), and distribution agents (e.g., retailer, vendor, etc.).

As shown, one or more distribution orders (e.g., location order 430A, 430B, 430C, etc.) are generated by the process 400 for distributing products (e.g., as defined by the item information 404) by one or more retail locations (e.g., as defined by the location information 406A, 406B, 406C, etc.). Production distribution, for example, is performed by the system 100 (shown in FIG. 1), based at least in part on information associated with the location orders 430A-C.

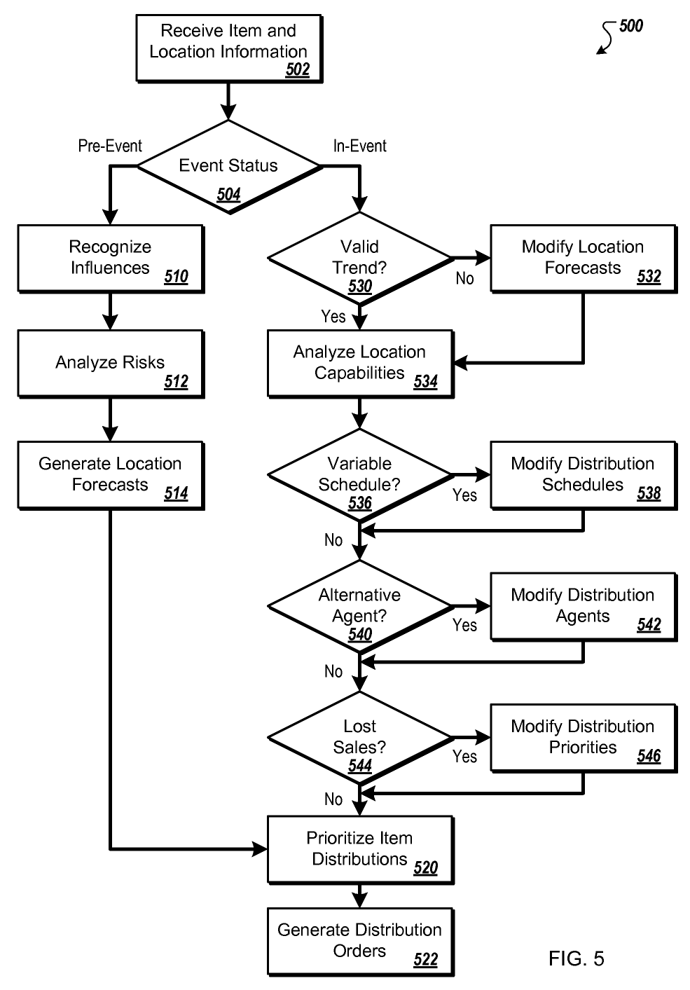

FIG. 5 is a flow chart showing an example process 500 for distributing products to retail locations. The process 500 is optionally performed by the recognition module 140, the forecasting module 142, and the distribution module 144 in the system 100 (as shown in FIG. 1) and will be described as such for clarity. A particular order and number of steps are described for the process 500. However, it will be appreciated that the number, order, and type of steps required for the process 500 is optionally different in other examples.

In step 502, for example, the system 100 receives item and location information. For example, item information is provided by the products data store 126, and location information is provided by any or all of the inventory data stores (114A, 114B, etc.), the sales data stores (116A, 116B, etc.), and the schedule data stores (118A, 118B, etc.). The item and location(s), for example, may be relevant to one or more identified events or conditions (e.g., a promotional event, provided by the events data store 124).

In step 504, an event status (e.g., pre-event, in-event) is determined. In some implementations, processing logic is based at least in part on the event status. For example, a series of decisions and steps included in the process 500 may optionally vary, depending at least in part on whether an identified event has yet to begin, is in process, or has already occurred.

In the present example, if a determination is made that an event has not yet begun, influences related to the event are recognized (e.g., by the recognition module 140) in step 510. For example, various attributes (e.g., medium, message, coverage, etc.) associated with a promotional event (e.g., an advertised product sale) are identified, and a potential influence on product sales is predicted. As another example, attributes related to various weather, traffic, or construction conditions are identified and used for predicting a potential influence on product sales.

In step 512, risks related to product sales and distribution are analyzed (e.g., by the forecasting module 142). For example, a previously recognized promotional event may be forecasted to have a positive effect on product sales by one or more retail locations. As another example, predicted levels of traffic or construction, or weather predictions may be used as factors in forecasting product sales. Heavy levels of traffic or construction, for example, may be determined to have a negative effect on product distribution (e.g., due to an increase in delivery times, a reduction in confidence levels, etc.) for one or more retail locations. Inclement weather, for example, may similarly be determined to have a negative effect on product distribution, but a positive or negative effect on product sales, depending on the particular product and on the particular retail location. For example, inclement weather conditions (e.g., a snowstorm) may be determined to have a positive effect on product sales related to products or product categories (e.g., shovels, salt, scrapers, winter apparel, etc.) predicted to be in high demand during the weather event in the vicinity of one or more affected retail locations. Based at least in part on analyzed risks to product sales and distribution, and on product sales trends for one or more retail locations, in step 514 sales forecasts for the product are generated (e.g., by the forecasting module 142) for one or more of the locations.

Item distributions are prioritized (e.g., by the distribution module 144) in step 520, in the present example. For example, prior to the start of a promotional event, product distribution for a particular retail location may be assigned a higher priority. Newly released items, for example, may be preferentially distributed to one or more retail locations promoting the release. In step 522, distribution orders are generated (e.g., by the distribution module 144) for distributing item quantities to one or more retail locations.

In the present example, if a determination is made that an event is in process, a previously forecasted sales trend (e.g., a sales trend used for generating location forecasts in step 514) is validated (e.g., by the forecasting module 142) in step 530. For example, actual product sales for the event may be compared with previously forecasted product sales to determine the validity of the product sales forecast for the remainder of the event. As another example, product sales associated with two or more retail locations may be compared to identify sales aberrations and to refine product sales forecasts for the locations. If the trend is determined to be invalid or inaccurate, product sales forecasts for the location for the remainder of the event are modified in step 532.

Location capabilities are analyzed (e.g., by the distribution module 144) in step 534. For example, factors related to storage space (e.g., floor, retail area, backroom, warehouse, etc.), as well as factors related to product availability (e.g., damage rates, shrinkage rates, markdown rates, etc.) and product distribution (e.g., receiving schedules, unloading schedules, stocking schedules, distribution agents, etc.) are used for generating decisions related to item distribution for one or more retail locations. Additionally, for example, previously forecasted (and optionally modified) sales trends are used as factors in determining product distribution quantities and prioritizing product distribution to one or more of the locations.

In the present example, if a determination is made (e.g., by the distribution module 144) in step 536 that the location includes a variable or flexible schedule for receiving, unloading, or stocking product shipments, one or more product distribution schedules may be modified in step 538. For example, if it is determined that a particular location is capable of receiving product shipments on a flexible schedule, and the location is predicted to sell out of a particular product before a previously scheduled shipment is to be stocked, the receiving schedule for that location may be modified to receive a product shipment in time for items to be received, unloaded, and stocked such that product quantities will continually be available for sale. Correspondingly, if the location is predicted to not sell out of a particular product until after a previously scheduled shipment is to be stocked, the receiving schedule for that location may be modified to receive a product shipment at a later time. By dynamically modifying delivery schedules, for example, expenses associated with carrying an excessive amount of unproductive inventory may be reduced, while reducing the possibility of lost product sales.

In the present example, if a determination is made (e.g., by the distribution module 144) in step 540 that the location may receive product shipments from an alternative agent (e.g., a vendor), one or more distribution agents may be modified in step 542. For example, it may be determined that a particular retail location is capable of receiving product shipments from either a centralized distributer (e.g., the distribution center 120) or an alternate distribution agent (e.g., a product vendor). If the product vendor is capable of distributing a particular product (e.g., a newly released item, a product produced in the vicinity of the retail location, etc.) more efficiently or more quickly than the centralized distributer, a decision may be generated (e.g., by the distribution module 144) to select the alternate distribution agent.

In the present example, if a determination is made (e.g., by the distribution module 144) in step 544 that the location is subject to lost sales for a portion of the event, distribution priorities may be modified in step 546. For example, it may be determined that product quantities provided by a centralized distributer (e.g., the distribution center 120) are limited, and that a particular retail location is subject to lost sales. Distribution priorities, for example, may be modified such that another retail location receives an increased quantity of the product or a higher distribution priority, and that the location subject to lost sales receives a decreased quantity or a lower distribution priority.

Item distributions are prioritized (e.g., by the distribution module 144) in step 520 in the present example, based at least in part on decisions and modifications performed by the process 500 in previous steps. Correspondingly, distribution orders are generated in step 522, based at least in part on the prioritization. By implementing a flexible process and by considering data and factors from multiple sources, for example, methods for product distribution may be dynamically modified to adapt to changing events and conditions in a retail distribution environment. Optionally, the process 500 or a variation thereof can be used to perform a product distribution simulation. For example, by specifying data representative of a conceptual product or a conceptual retail location (e.g., at step 502), the process 500 can model distribution of one or more new products to one or more new retail locations, based on real or simulated events and conditions.

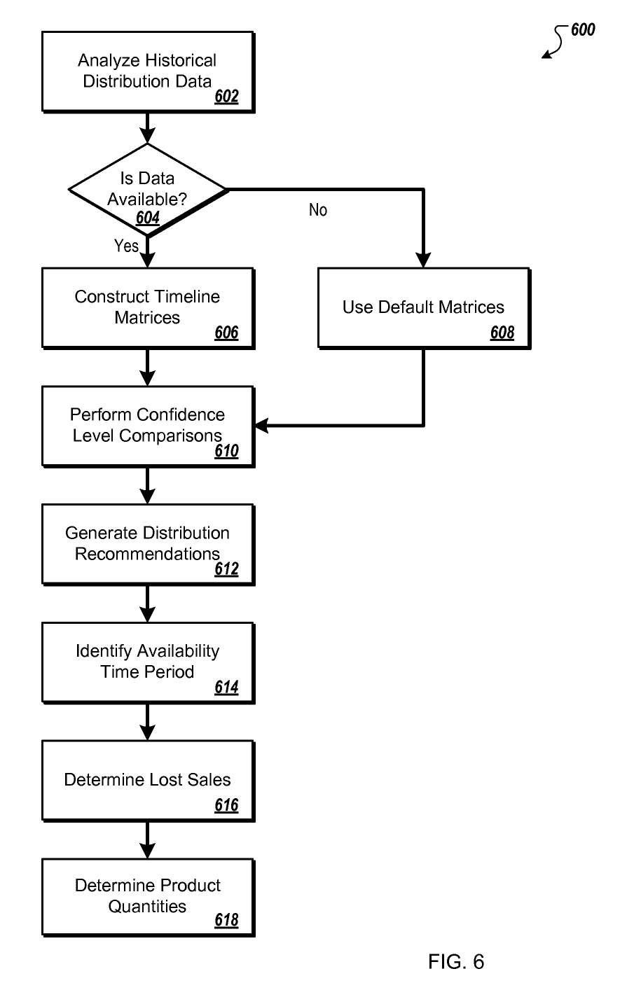

FIG. 6 is a flow chart showing an example process 600 for determining product quantities for distribution to retail locations. The process 600 is optionally performed by the distribution module 410 (as shown in FIG. 4) and will be described as such for clarity. A particular order and number of steps are described for the process 600. However, it will be appreciated that the number, order, and type of steps required for the process 600 is optionally different in other examples.

In some implementations, the process 600 can run at intervals (e.g., once a week on a Saturday, every other day, etc.) to determine product distribution quantities for one or more retail locations. In some implementations, the process 600 can be executed multiple times for each retail location, based on various delivery methods or handling types, and based on a number of projected timeframes. For example, for a distribution center employing five different delivery methods or handling types and projecting product distributions for three weeks in the future, the process may be run fifteen (5×3) times for each retail location.

In step 602, for example, the distribution module 410 analyzes historical distribution data. For example, using the schedule analyzer 412 (as shown in FIG. 4), the distribution module 410 may determine merchandise delivery schedules for one or more retail locations. Optionally, unload schedules for each of the retail locations may be converted to Available for Sales (AFS) schedules.

In step 604, it is determined whether (or what amount of) historical distribution data is available. In some implementations, if data is available, or if a specified amount of data is available, the process 600 optionally constructs one or more timeline matrices (step 606) for one or more of the retail locations. In some implementations, if data is unavailable, or if a specified amount of data is unavailable, the process 600 optionally uses one or more default matrices (step 608) for one or more of the retail locations. The default matrices, for example, can specify Sunday distribution and Wednesday AFS.

In step 606, for example, using an AFS schedule, a matrix can be constructed for each AFS day. In some implementations, a series of weighted percentages may be provided (e.g., by a control table) and applied to the historical data. Optionally, some of the historical data (e.g., particular days or weeks) may be filtered or excluded from consideration. Referring to Table 1, an example set of weighted percentages is shown for application to historical distribution data. In some implementations, the weighted percentages may be modified under certain circumstances. For example, if historical distribution data is available (or unavailable) for a specified timeframe (e.g., 12 weeks, 8 weeks, 4 weeks, etc.) the weighted percentages may be proportionally adjusted over a greater (or lesser) amount of time, with the sum of the percentages equaling a total of 100 percent.

TABLE 1

| WEEK | WEIGHTED PERCENT |
|---|---|
| 1 | 62.799462545% |
| 2 | 25.174845880% |
| 3 | 8.801824916% |
| 4 | 2.558755343% |
| 5 | 0.572356272% |
| 6 | 0.085916326% |
| 7 | 0.006655305% |
| 8 | 0.000183414% |

In some implementations, a series of equations can be used for constructing timeline matrices. For example, if the weighted sum of the number of product distributions created equals C, and if the weighted sum of the number of product distributions received equals R, for the past week, the respective variables are C1 and R1, and the weighted percent from Table 1 is W1. The corresponding equation in the present example is as follows:

C=(C1×W1)+(C2×W2)+(C3×W3)+(C4×W4)+(C5×W5)+(C6×W6)+(C7×W7)+(C8×W8)

R=(R1×W1)+(R2×W2)+(R3×W3)+(R4×W4)+(R5×W5)+(R6×W6)+(R7×W7)+(R8×W8)

For example, the weighted percentage for a Sunday distribution and a Monday AFS is R/C. Using similar calculations, for example, a series of matrix cells may be populated. Referring to Table 2, an example timeline matrix is shown for a retail location and a distribution week.

TABLE 2

| | | DISTRIBUTION DAY | | | | | | | |
|---|---|---|---|---|---|---|---|---|---|
| | | SUN | MON | TUE | WED | THU | FRI | SAT | SUN |
| AFS | SUN | | | | | | | | |
| DAY | MON | 10 | 0 | | | | | | |
| | TUE | | | | | | | | |
| | WED | 100 | 95 | | 0 | | | | |
| | THU | | | | | | | | |
| | FRI | | 100 | | 100 | | 0 | | |
| | SAT | | | | | | | | |

In the present example, Monday, Wednesday, and Friday may be considered as AFS days at the retail location. Optionally, additional matrices may be created for prior or subsequent distribution time periods (e.g., distribution weeks).

In step 610, confidence level comparisons are performed. For example, using the confidence analyzer 416 (shown in FIG. 4), the distribution module 410 determines one or more matrix cells from populated timeline matrices that correspond with a confidence percentage level (e.g., an administrative parameter, a dynamically generated variable, a variable depending on retail location or product properties, etc.). For example, referring to Table 2, once the matrix cells are populated, a recommended distribution day may be selected for each AFS day. In the present example, for each AFS day (e.g., Monday, Wednesday, and Friday), analyzing the cells from right to left, the first cell satisfying the confidence percentage level may be selected. If none of the cells satisfy the confidence percentage, cells from additionally created matrices are optionally considered to select a recommended distribution day.

In step 612, distribution recommendations are generated by considering, at least in part, one or more recommended distribution days. In some implementations, a recommendation table may be created for one or more of the retail locations. Referring to Table 3, an example recommendation table is shown for a particular retail location.

TABLE 3

| FUTURE WK. | DIST. WK. | DIST. DAY | AFS DAY |
|---|---|---|---|
| 1 | −1 | FRI | MON |
| 1 | 1 | MON | WED |
| 1 | 1 | WED | FRI |
| 2 | −1 | FRI | MON |
| 2 | 1 | MON | WED |
| 2 | 1 | WED | FRI |
| 3 | −1 | FRI | MON |
| 3 | 1 | MON | WED |

In the present example, if the distribution day and the AFS day are in the same week, then the distribution week is 1. If the distribution day is one week prior to the AFS day, then the distribution week is −1 (and so on).

In step 614, an availability time period is identified. For example, using the opportunity analyzer 418 (shown in FIG. 4), the distribution module 410 identifies an AFS day for a current distribution day (e.g., from a recommendation table). If the current distribution day is not a recommended distribution day, the opportunity analyzer 418 optionally selects the next day as a distribution day, and matches its corresponding AFS day. In some implementations, the availability time period can be calculated by identifying the days between the current day and the AFS day. In some implementation, a more granular timeframe (e.g., hours or minutes) may be considered.

In step 616, lost sales are determined. In some implementations, a sales forecast (e.g., as determined by the forecasting module 310, shown in FIG. 3) for one or more retail locations is used as a factor in determining lost sales. For example, lost sales may be calculated as the amount of sales forecasted for a particular product at a particular location, minus the amount of product on hand and the amount of product on withdrawal. Correspondingly, if the amount of product on hand plus the amount of product on withdrawal is less than the sales forecast, lost sales may be considered as zero.

In step 618, product quantities are determined for distribution to one or more retail locations. For example, using the prioritizer 420 (shown in FIG. 4), the distribution module 410 calculates an amount of product to distribute to each of the retail locations. In some implementations, the product quantity can be based at least in part on need associated with a promotional event. For example, a determined product quantity may be calculated as forecasted sales for a particular product at a particular retail location, minus a commitment amount and a lost sales amount. Thus, in some implementations, the prioritizer 420 may reduce distribution of product quantities to retail locations projected to be subject to lost sales during a promotional event.

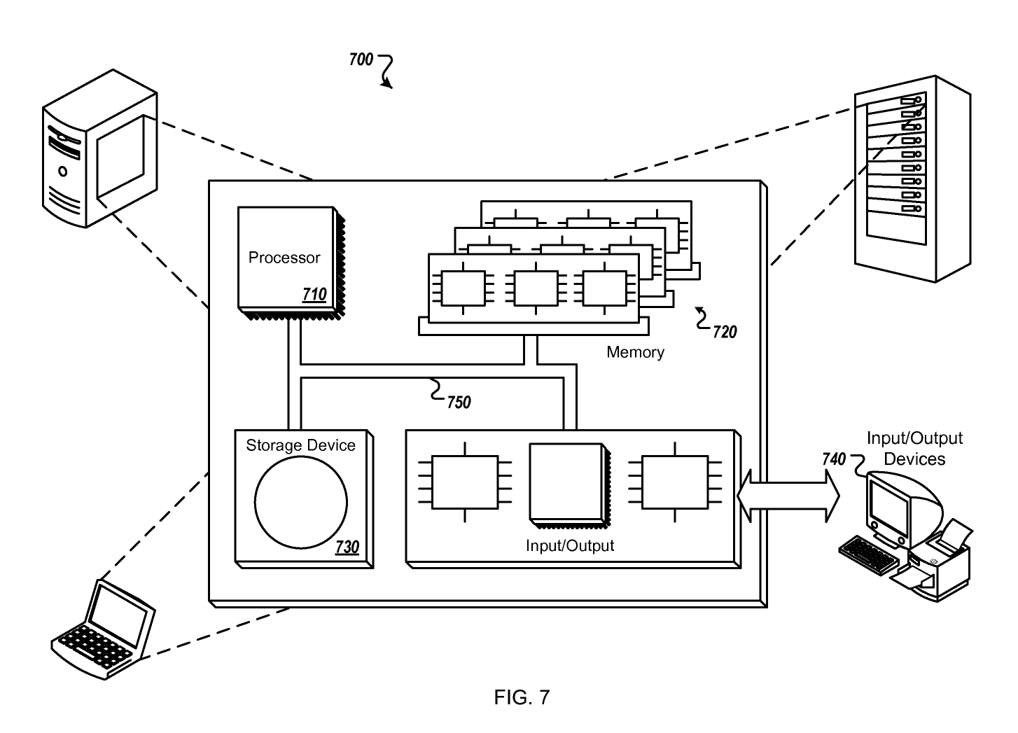

FIG. 7 is a schematic diagram of a generic computer system 700. The system 700 is optionally used for the operations described in association with any of the computer-implement methods described previously, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 610 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 is optionally a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features in some instances are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications are optionally made without departing from the spirit and scope of this disclosure. Accordingly, other embodiments are within the scope of the following claims.

What is claimed is:

1. A computer implemented method for distributing products to retail locations, the method comprising:
receiving data associated with a product and retail locations at which the product is to be sold;
recognizing an event predicted to affect sales of the product at one or more of the retail locations;
identifying, with a computer, sales data for the product at each of the retail locations;
forecasting sales of the product at each of the retail locations based at least in part on the identified sales data and the recognized event;
identifying, with a computer, receiving attributes of each of the retail locations, wherein the receiving attributes are premised at least in part on unload schedules and stocking times;
determining, with a computer, a confidence level for each of the retail locations, based at least in part on the identified receiving attributes, wherein the confidence level is associated with a probability that the product will be stocked at the retail location at a particular time;
determining, with a computer, a quantity of the product to be delivered to each of the retail locations based at least in part on the forecasted sales;
prioritizing, with a computer, distribution of the product to each of the retail locations based at least in part on the identified receiving attributes and the determined confidence levels; and
generating a distribution order for at least one of the retail locations for delivery of determined product quantities.

2. The method of claim 1, wherein the sales data is used to identify a sales trend for each of the retail locations, wherein the sales trend is validated by performing a trend comparison.

3. The method of claim 1, wherein the receiving attributes are also based on data associated with warehousing capacity and retail area capacity.

4. The method of claim 1, wherein the unload schedules of one or more of the retail locations are variable, and wherein the prioritization also includes adjusting a delivery schedule for one or more of the retail locations.

5. The method of claim 1, wherein the method further comprises determining a distribution agent for each of the retail locations based at least in part on the receiving attributes of the retail location and on delivery capabilities of the distribution agent, and wherein the distribution order specifies the distribution agent.

6. The method of claim 1, wherein the prioritization includes adjusting the determined quantities of the product to be delivered.

7. The method of claim 1, wherein the event is related to promotion of the product.

8. The method of claim 7, wherein the event includes a timeframe with a start and an end and wherein the prioritization is also based at least in part on the timeframe.

9. The method of claim 8, wherein the prioritization includes specifying a higher priority for distribution of the product to one or more of the retail locations before the start of the event.

10. The method of claim 8, wherein the prioritization includes specifying a lower priority for distribution of the product to one or more of the retail locations projected to be subject to lost sales before the end of the event.

11. A system for distributing items to retail locations, the system comprising:
an item information system to store and provide information related to items made available for purchase by one or more retail locations;
an event information system to store and provide information associated with events related to one or more of the items or retail locations;
an inventory information system to store and provide information related to item inventory by one or more of the retail locations;
a sales information system to store and provide information related to item sales by one or more of the retail locations;
a schedule information system to store and provide information related to unload schedules or stocking times at one or more of the retail locations; and
a distribution server to i) identify events that affect item sales, ii) identify item sales data, iii) predict sales based at least in part on the identified item sales data and the events, iv) identify a likelihood that an item will be stocked at a retail location within a time period after shipment based at least in part on unload schedules or stocking times, and iv) determine item quantities to be shipped based at least in part on the predicted sales and based further on the identified likelihood.

12. The system of claim 11, wherein the unload schedules and stocking times are variable and wherein the determination of item quantities to be shipped includes adjusting delivery schedules.

13. The system of claim 11, wherein the events include at least one condition selected from the group consisting of weather conditions, traffic conditions, and construction conditions.

14. The system of claim 11, wherein the events are related to a retail product promotion.

15. The system of claim 14, wherein the events include timeframes and wherein the determination of item quantities includes prioritization based at least in part on the timeframes.

16. The system of claim 14, wherein attributes of the events are used to predict a degree of influence on item sales, the attributes including at least one selected from the group consisting of medium, message, and coverage.

17. A computer program product tangibly embodied in an information carrier, the computer program product including instructions that, when executed, perform operations for distributing products to retail locations, the operations comprising:
receiving data representative of a product and one or more retail locations;
recognizing an event, wherein the event is predicted to affect sales of the product by one or more of the retail locations;
identifying sales data for each of the retail locations, wherein the sales data is related to sales of the product by the retail locations;
forecasting sales of the product by each of the retail locations, based at least in part on the identified sales data and the recognized event;
identifying receiving attributes of each of the retail locations, wherein the receiving attributes include unload schedules and stocking times;
determining a confidence level for each of the retail locations, based at least in part on the identified receiving attributes, wherein the confidence level is associated with a probability that the product will be stocked at the retail location at a particular time;
determining a quantity of the product to be delivered to each of the retail locations, based at least in part on the forecasted sales;
prioritizing distribution of the product to each of the retail locations, based at least in part on the identified receiving attributes and the determined confidence levels; and
generating a distribution order for each of the retail locations for delivering the product quantities.

18. The computer program product of claim 17, wherein prioritizing distribution of the product is also based at least in part on product aspects, wherein the aspects include at least one selected from the group consisting of release date, expiration date, retail pricing, and competitor pricing.

19. The computer program product of claim 17, wherein the operations further comprise determining a distribution agent for each of the retail locations, wherein the determination is based at least in part on the receiving attributes of the retail location and on delivery capabilities of the distribution agent, and wherein the generated distribution order specifies the distribution agent.

20. The computer program product of claim 17, wherein the operations further comprise receiving data representative of a simulated product or simulated retail location and performing a distribution simulation.
